(19) United States
(12) Patent Application Publication
(10) Pub. No.: US 2003/0230395 A1
(43) Pub. Date: Dec. 18, 2003

(54) Vehicle air-conditioning system

(76) Inventors: Koichi Kaiyama, Utsunomiya-shi (JP); Minoru Ido, Utsunomiya-shi (JP); Junya Ohta, Utsunomiya-shi (JP); Junji Goto, Chiryu-City (JP)

Correspondence Address: BIRCH STEWART KOLASCH & BIRCH, PO BOX 747, FALLS CHURCH, VA, 22040-0747, US

(21) Appl. No.: 10/462,734

(22) Filed: Jun. 17, 2003

(30) Foreign Application Priority Data
Jun. 18, 2002 (JP) 2002-177178

(51) Int. Cl. B60H 3/00; B61D 27/00; B60H 1/32

(52) U.S. Cl. 165/42; 62/244

(57) ABSTRACT

A vehicle air-conditioning system has a substantially upright evaporator, a substantially upright heater core, an inlet pipe for introducing engine coolant water into an inlet port of the heater core, and an outlet pipe for discharging engine coolant water from an outlet port of the heater core. The outlet port is disposed upwardly of the inlet port. The outlet pipe extends over the evaporator and is connected to an engine. The outlet pipe has an end connected to the outlet port and directed upwardly from the outlet port. The inlet pipe extends below the evaporator and is connected to the engine.

### BACKGROUND OF THE INVENTION

1. Field of the Invention

The present invention relates to a vehicle air-conditioning system having an evaporator and a heater core for air-conditioning the passenger's compartment of a vehicle, and more particularly to a vehicle air-conditioning system having an evaporator, a heater core, and outlet and input pipes connected to the heater core and disposed respectively above and below the evaporator.

2. Description of the Related Art

FIG. 5 of the accompanying drawings shows a conventional vehicle air-conditioning system 100. As shown in FIG. 5, the conventional vehicle air-conditioning system 100 adjusts the temperature and humidity of air in the passenger's compartment of a vehicle with an evaporator 102 and a heater core 104. Specifically, the evaporator 102 cools air that passes therethrough with the heat of vaporization of an air-conditioner refrigerant. The heater core 104 heats air that passes therethrough with hot water (engine coolant water) that is heated by the engine. The hot water heated by the engine is introduced through an inlet pipe 106 into the heater core 104, exchanges heat with the air, and discharged from the heater core 104 through an outlet pipe 108. In typical vehicles, the engine is positioned rightward of the evaporator 102 in FIG. 5 (forward in the vehicle). Therefore, the inlet pipe 106 and the outlet pipe 108 which are connected to the heater core 104 extend in the vicinity of the evaporator 102. The heater core 104 is connected to a radiator and shares the hot water from the engine with the radiator.

For adjusting both the temperature and humidity of air in the passenger's compartment, air drawn into the vehicle air-conditioning system 100 is first cooled by the evaporator 102 and then heated by the heater core 104. In order to produce a smooth flow of air, the evaporator 102 and the heater core 104 are often disposed substantially parallel and closely to each other.

Since each of the evaporator 102 and the heater core 104 is a heat exchanger, they have a wide area for better heat exchange efficiency. The evaporator 102 and the heater core 104 which have a wide area are frequently vertically oriented (standing upright) due to layout limitations. The evaporator 102 should preferably be replaceable. According to some designs, the evaporator 102 has a structure slidable laterally with respect to the vehicle air-conditioning system 100, i.e., in the directions indicated by the arrow A in FIG. 5.

To prevent the inlet pipe 106 and the outlet pipe 108 from interfering with the evaporator 102 as it is slid laterally, the inlet pipe 106 and the outlet pipe 108 are generally positioned so as to extend below the evaporator 102.

Generally, the inlet pipe 106 is connected to a lower portion of the heater core 104, and the outlet pipe 108 is connected to an upper portion of the heater core 104. With this pipe layout, even when air is introduced into the inlet pipe 106 and enters the heater core 104, since the air has a specific gravity much smaller than the engine coolant water, the air rises naturally and can be discharged from the heater core 104 into the outlet pipe 108 together with the flow of the hot water.

When air is trapped in the upper portion of the heater core 104, it is discharged from the heater core 104 into the outlet pipe 108 together with the flow of the hot water. However, since the outlet pipe 108 extending from its junction 110 to the heater core 104 is directed downwardly, the air trapped in the upper portion of the heater core 104 cannot quickly be discharged through the outlet pipe 108. The junction 110 has a complex structure including a sealing mechanism therein, so that the air may possibly stay trapped in the junction 110 for a long period of time. When the engine coolant water is replaced, air is also likely to enter the heater core 104 via the inlet pipe 106 and hence to stay trapped in the upper portion of the heater core 104.

The air trapped in the vicinity of the junction 110 produces noise when the hot water flows through the junction 110, making the passengers of the vehicle feel uncomfortable or anxious. If a large amount of air is trapped in the vicinity of the junction 110, then the heater core 104 has its heat exchange efficiency lowered.

Therefore, it is necessary to remove trapped air sufficiently from the heater core 104. For removing trapped air sufficiently from the heater core 104, a water pump incorporated in the engine coolant water circulation system needs to be operated for a long period of time.

### SUMMARY OF THE INVENTION

It is a general object of the present invention to provide a vehicle air-conditioning system which is capable of preventing air from being trapped in a heater core and allowing engine coolant water to be replaced in a short period of time.

A major object of the present invention is to provide a vehicle air-conditioning system which permits an evaporator to be removed easily.

Another object of the present invention is to provide a vehicle air-conditioning system which reduces unwanted heat dissipation and has high heat exchange efficiency.

According to the present invention, there is provided a vehicle air-conditioning system comprising an evaporator for cooling air passing therethrough by evaporating a refrigerant therein, a heater core for heating air passing therethrough through a heat exchange with engine coolant water heated by an engine, the heater core being substantially standing upright and having an inlet port and an outlet port, an inlet pipe for introducing the heated engine coolant water from the engine into the inlet port, an outlet pipe for discharging the engine coolant water, which has heated the air in the heater core, from the outlet port, the outlet port being positioned upwardly of the inlet port, the outlet pipe being connected to the outlet port and directed horizontally or upwardly from the outlet port, the outlet pipe extending over the evaporator and being connected to the engine.

Because the outlet pipe connected to the outlet port is directed horizontally or upwardly from the outlet port, air is less likely to be trapped in the heater core, and the engine coolant water can be replaced in a short period of time. As the outlet pipe extends over the evaporator and is connected to the engine, the outlet pipe does not obstruct the replacement of the evaporator.

The inlet pipe may be connected to the inlet port and directed horizontally or downwardly from the inlet port, and the inlet pipe may extend below the evaporator and be connected to the engine. With this arrangement, air does not tend to be trapped in the inlet pipe, and the inlet pipe does not obstruct the replacement of the evaporator.

If the evaporator is substantially standing upright, then the evaporator and the heater core are disposed substantially parallel to each other, allowing air for being adjusted in temperature to pass easily therethrough.

If the outlet pipe is covered at least partly with an insulation member, then unwanted thermal dissipation is reduced, and heat exchange efficiency is increased.

The inlet pipe or the outlet pipe may be covered at least partly with a protective cover.

If the outlet pipe comprises a bent metal pipe, then the engine coolant water and any trapped air can easily flow through the outlet pipe, so that trapped air is quickly discharged by the flow of the engine coolant air.

If the engine coolant water is poured through a coolant water inlet disposed at a position higher than an uppermost portion of the outlet pipe, then the engine coolant water can reliably fill up the heater core, the inlet pipe, and the outlet pipe.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a vertical cross-sectional view of a vehicle air-conditioning system according to the present invention and parts associated therewith;

FIG. 2 is a perspective view of the vehicle air-conditioning system;

FIG. 3 is a perspective view of a heater core, an inlet pipe, and an outlet pipe of the vehicle air-conditioning system;

FIG. 4 is a front view of the heater core, an end of the inlet pipe, and an end of the outlet pipe of the vehicle air-conditioning system; and

FIG. 5 is a perspective view of an evaporator, a heater core, an inlet pipe, and an outlet pipe of a conventional vehicle air-conditioning system.

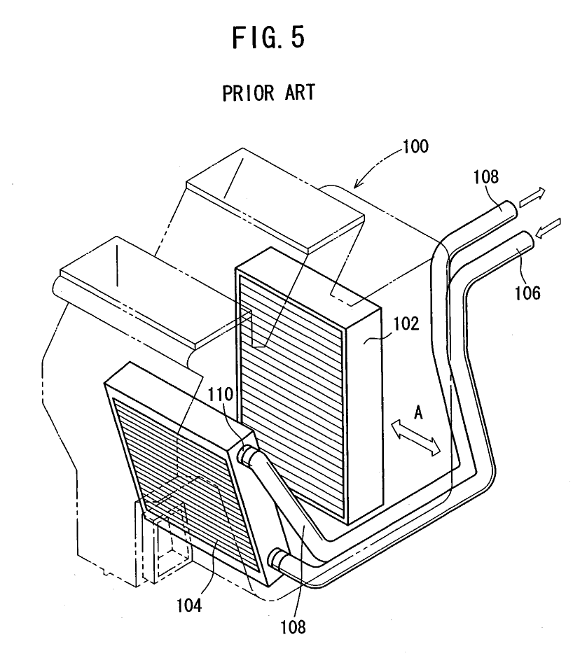

### DESCRIPTION OF THE PREFERRED EMBODIMENT

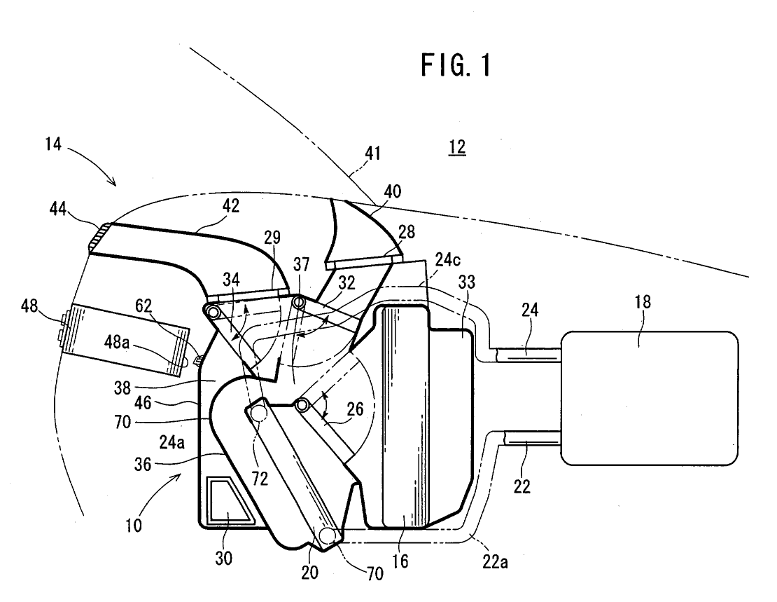

A vehicle air-conditioning system according to an embodiment of the present invention will be described below with reference to FIGS. 1 through 4.

As shown in FIG. 1, a vehicle air-conditioning system 10 according to the embodiment of the present invention serves to adjust the temperature and humidity of air in a passenger's compartment of a vehicle 12, and is disposed within a front console 14 of the vehicle 12. The vehicle air-conditioning system 10 has a blower fan (not shown) for selectively supplying internal air or external air, an evaporator 16 for cooling and dehumidifying air supplied from the blower fan by evaporating a refrigerant, a heater core 20 for heating air through a heat exchange with coolant water from an engine 18, an inlet pipe 22 for introducing hot water from the engine 18 into the heater core 20, and an outlet pipe 24 for delivering hot water, which has heated air, from the heater core 20 to the engine 18. The inlet pipe 22 extends below the evaporator 16 and is connected to the engine 18. The outlet pipe 24 extends over the evaporator 16 and is connected to the engine 18. The hot water means coolant water heated by the waste heat generated by the engine 18. In the description which follows, engine coolant water at a low temperature will be referred to as “engine coolant water” and engine coolant water at a high temperature as “hot water”.

The vehicle air-conditioning system 10 also has a compressor, a condenser, and an expansion valve (not shown). The refrigerant which is evaporated by the evaporator 16 is compressed by the compressor and then liquefied by the condenser. The liquefied refrigerant is converted by the expansion valve into a mist which returns to the evaporator 16 for circulation.

The vehicle air-conditioning system 10 also has an air mixing door 26 for adjusting the amount of air that has passed through the evaporator 16 and which is to be introduced into the heater core 20, and two selector doors 32, 34 for selecting three air outlets, i.e., a defroster outlet 28, a face outlet 29, and a foot outlet 30, by changing air passages.

Air supplied from the blower fan is introduced into a space 33 in front of the evaporator 16, flows through the evaporator 16, and is controlled in direction by the air mixing door 26. Part or all of the air is introduced into the heater core 20 by the air mixing door 26 depending on its opening. When the air mixing door 26 is fully closed, the air is blocked from entering into the heater core 20.

When the air mixing door 26 is fully opened, all of the air that has passed through the evaporator 16 is introduced into the heater core 20. After having passed through the heater core 20, the air flows upwardly through a first air passage 36 into a space 37 at an outlet of the first air passage 36. When the air mixing door 26 is fully closed, the air that has passed through the evaporator 16 is not supplied to the heater core 20, but directly supplied to the space 37. From the space 37, the air is delivered into the passenger's compartment from the defroster outlet 28 and/or the face outlet 29 by the selector doors 32, 34 depending on their opening. Depending on the opening of the selector doors 32, 34, part or all of the air is introduced into a second air passage 38, from which the air is delivered into the passenger's compartment through the foot outlet 30. Specifically, the air introduced into the defroster outlet 28 is delivered through a duct 40 toward a front windshield 41. The air introduced into the face outlet 29 is delivered through a duct 42 and a ventilation grill 44 into the passenger's compartment. The air introduced into the foot outlet 30 is delivered through a duct (not shown) toward the feet of the passenger.

The second air passage 38 of the vehicle air-conditioning system 10 is partly defined by a partition comprising a thin resin panel 46. A radio unit 48 mounted on the front console 14 is positioned near the resin panel 46 at its surface facing the passenger's compartment. The resin panel 46 is molded of polypropylene, for example.

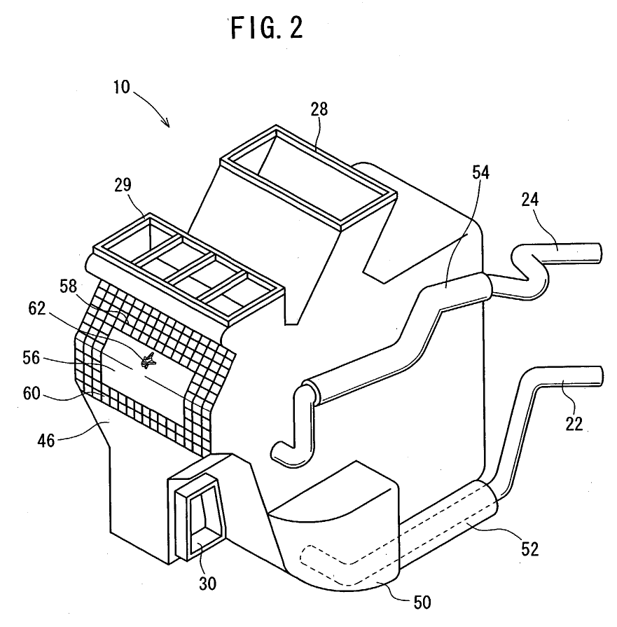

As shown in FIG. 2, the inlet pipe 22 is covered at least partly with a first protective cover 50 and a second protective cover 52 which are made of synthetic resin. The outlet pipe 24 is covered at least partly with an insulation member 54. The first protective cover 50, the second protective cover 52, and the insulation member 54 serve to prevent persons (passengers or maintenance personnel) from directly touching the inlet pipe 22 and the outlet pipe 24 inadvertently. If the first protective cover 50 and the second protective cover 52 are made of a thermal insulation, then unwanted heat dissipation is reduced, and the heater core 20 has high heat exchange efficiency.

The resin panel 46 has a grid-like pattern of vertical and horizontal grooves 58 defined in a peripheral region of its surface 56 close to the radio unit 48 (see FIG. 1). The resin panel 46 has a sufficient thickness in the grooves 58 for providing desired mechanical strength to the resin panel 46 for resistance against vibrations and fatigue while the vehicle is running normally.

The resin panel 46 also has a plurality of blocks 60 surrounded by the grooves 58 in the grid-like pattern. The surface 56 of the resin panel 46 has a protrusion 62 disposed substantially centrally thereon at an area closest to the radio unit 48.

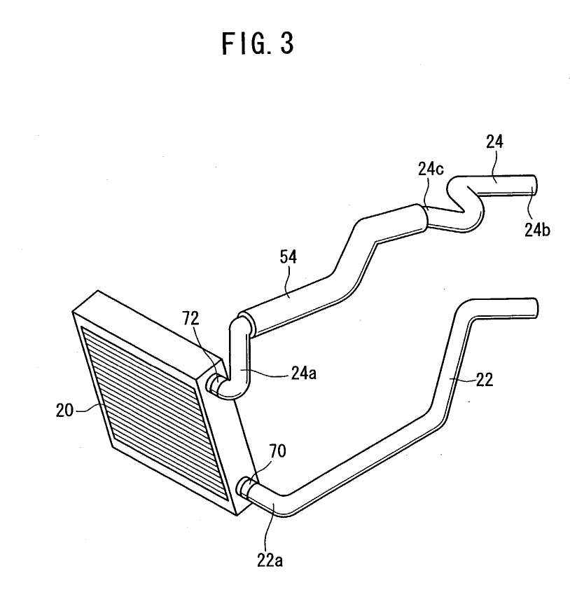

As shown in FIG. 3, the inlet pipe 22 has an end 22a connected to an inlet port 70 on a lowermost portion of a side panel of the heater core 20. The end 22a connected to the inlet port 70 lies horizontally. Alternatively, the end 22a connected to the inlet port 70 may be directed downwardly from the horizontal plane. The outlet pipe 24 has an end 24a connected to an outlet port 72 on an uppermost portion of the side panel of the heater core 20. The end 22a connected to the inlet port 70 extends upwardly from the outlet port 72. The end 22a connected to the inlet port 70 may be directed upwardly from the horizontal plane.

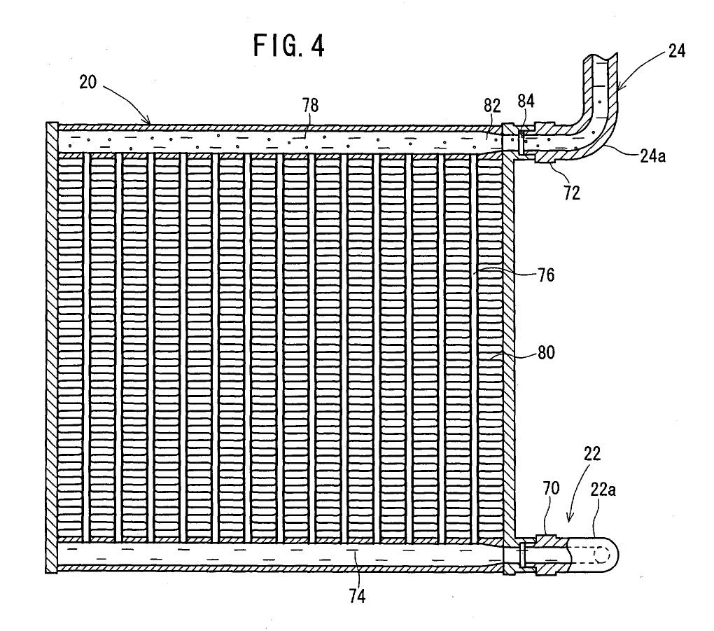

As shown in FIG. 4, hot water flowing from the inlet port 70 into the heater core 20 is introduced into a lower passage 74 defined in and extending along a lower side of the heater core 20, and then flows upwardly through a plurality of vertical thin pipes 76 connected to the lower passage 74. The hot water which flows upwardly enters an upper passage 78 defined in and extending along an upper side of the heater core 20, and then is discharged from the outlet port 72 into the outlet pipe 24.

A plurality of wavy fins 80 are interposed between the thin pipes 76 and contact the thin pipes 76. Air to be adjusted in temperature by the vehicle air-conditioning system 10 is heated when it flows across the heater core 20 through the gaps between the fins 80.

As described above, the vehicle air-conditioning system 10 heats air through a heat exchange with the heater core 20 using the waste heat from the engine 18 in order to heat the air in the vehicle 12. The engine coolant water for introducing the waste heat from the engine 18 into the heater core 20 comprises water or a dedicated liquid. The engine coolant water is heated by the engine 18 into hot water, which is supplied to the heater core 20 and a radiator (not shown) by a water pump (not shown). The engine coolant water should preferably be replaced with fresh engine coolant water at predetermined time intervals.

A process of replacing the engine coolant water in the heater core 20 of the vehicle air-conditioning system 10 will be described below with reference to FIG. 4.

For replacing the engine coolant water, a drain cock (not shown) on the heater core 20 is opened to discharge the engine coolant water from the heater core 20. The engine coolant water is now drained from the heater core 20, the inlet pipe 22, and the outlet pipe 24, drawing air into the heater core 20. After the engine coolant water is discharged, the drain cock is closed.

Then, fresh engine coolant water is poured in from a coolant water inlet of the engine coolant water circulation system, e.g., a radiator inlet port. The poured engine coolant water first fills the lower inlet pipe 22. Since the end 22a of the inlet pipe 22 is horizontally connected to the inlet port 70 on the heater core 20, the inlet pipe 22 and the end 22a are filled with the engine coolant water with no air trapped therein.

Then, the poured engine coolant water flows from the inlet port 70 into the heater core 20, and rises in water level through the lower passage 74, the thin pipes 76, and the upper passage 78.

After having filled the upper passage 78, the engine coolant water flows from the outlet port 72 into the outlet pipe 24. Because the end 24a of the outlet pipe 24 which is connected to the outlet port 72 is directed upwardly from the outlet port 72, no air is trapped in the end 24a, allowing the engine coolant water to rise in level smoothly in the end 24a.

When the engine coolant water rises in level in the end 24a of the outlet pipe 24, it also rises in level in an opposite end 24b (see FIG. 3) of the outlet pipe 24. Therefore, air is trapped in an uppermost portion 24c of the outlet pipe 24, which is positioned between the ends 24a, 24b, and remains trapped in the uppermost portion 24c.

When the engine coolant water circulation system is filled with the engine coolant water up to the end of the coolant water inlet, the pouring of the engine coolant water is stopped.

Then, the water pump is actuated to circulate the poured fresh engine coolant water to remove the trapped air, i.e., to bleed the engine coolant water circulation system. When the water pump is actuated, the engine coolant water flows from the inlet port 70 into the lower passage 74, then through the thin pipes 76 into the upper passage 78, from which the engine coolant water flows through the outlet port 72 into the outlet pipe 24. In the vicinity of the outlet port 72, a small amount of trapped air in a constricted passage 82 and a joint gap 84, which are positioned between the upper passage 78 and the outlet port 72, is carried by the flow of the engine coolant water into the outlet pipe 24. At this time, the trapped air moves with the flow of the engine coolant water. After the trapped air has reached the end 24a of the outlet pipe 24, it is discharged upwardly naturally due to the difference between the specific gravity of the air and the specific gravity of the engine coolant water. As the constricted passage 82 and the joint gap 84 are spaced from the end 24a by a small distance, the trapped air can easily move to the end 24a. Therefore, even if the flow of the engine coolant water contains turbulent streams or vortexes, the trapped air can quickly be discharged. Even if part of the trapped air in the vicinity of the outlet port 72 is not discharged, its amount is very small.

A relatively large amount of air is initially trapped in the uppermost portion 24c (see FIG. 3) of the outlet pipe 24 when the fresh engine coolant water is introduced. However, the trapped water is quickly discharged from the uppermost portion 24c when the engine coolant water is circulated by the water pump. The reason why the trapped water is quickly discharged from the uppermost portion 24c is as follows: The outlet pipe 24 is in the form of a bent metal pipe having a smooth inner surface free of projections and steps for allowing the engine coolant water and the trapped air to flow smoothly. Accordingly, the trapped water is quickly discharged by the flow of the engine coolant water from the outlet pipe 24.

Since no air is trapped in the inlet pipe 22 and the end 22a thereof, no new air finds its way into the heater core 20. Even if a small amount of air exists in the inlet pipe 22 or a portion of the engine coolant water circulation system which precedes the inlet pipe 22, the air is quickly discharged through the outlet port 72 and the outlet pipe 24.

The air discharged from the outlet pipe 24 reaches the coolant water inlet, lowering the level of the engine coolant water in the coolant water inlet. The engine coolant water is supplied again to raise the level of the engine coolant water in the coolant water inlet, whereupon the engine coolant water replacing process including the bleeding process is finished.

As described above, when fresh engine coolant water is poured into the vehicle air-conditioning system 10 to replace the old engine coolant water, the amount of any initially trapped water is very small. A small amount of water which may be trapped in the constricted passage 82 and the joint gap 84 can quickly be discharged when the poured engine coolant water is circulated. As no projections and steps are present on the inner surface of the outlet pipe 24, an amount of water trapped in the uppermost portion 24c of the outlet pipe 24 is quickly discharged by the circulation of the poured engine coolant water. Therefore, the bleeding process, in particular, of the engine coolant water replacing process can be carried out in a short period of time.

Inasmuch as no trapped water is present in the vicinity of the outlet port 72, noise due to trapped air is not produced when hot water flows through the outlet port 72 when the vehicle air-conditioning system 10 is in operation. Even if trapped air remains in the vicinity of the outlet port 72, its amount is so small that no noise is produced. The heater core 20 is capable of exchanging heat highly efficiently as no trapped air remains therein.

Even if trapped air remains in the uppermost portion 24c of the outlet pipe 24, since the inner surface of the outlet pipe 24 is smooth, basically no noise is produced when the trapped air moves along the smooth inner surface of the outlet pipe 24.

Because the inlet pipe 22 extends below the evaporator 16 and the outlet pipe 24 extends above the evaporator 16, when the evaporator 16 is slid laterally, its sliding movement is not obstructed by the inlet pipe 22 and the outlet pipe 24. Accordingly, the evaporator 16 can easily be replaced.

The coolant water inlet for pouring the engine coolant water therethrough may be located at a position higher than the uppermost portion 24c of the outlet pipe 24, so that the heater core 20, the inlet pipe 22, and the outlet pipe 24 can reliably be filled with the engine coolant water. The coolant water inlet may be positioned on the uppermost portion 24c of the outlet pipe 24.

Although a certain preferred embodiment of the present invention has been shown and described in detail, it should be understood that various changes and modifications may be made therein without departing from the scope of the appended claims.

What is claimed is:

1. A vehicle air-conditioning system comprising:
an evaporator for cooling air passing therethrough by evaporating a refrigerant therein;
a heater core for heating air passing therethrough through a heat exchange with engine coolant water heated by an engine, said heater core being substantially standing upright and having an inlet port and an outlet port;
an inlet pipe for introducing the heated engine coolant water from said engine into said inlet port;
an outlet pipe for discharging the engine coolant water, which has heated the air in said heater core, from said outlet port;
said outlet port being positioned upwardly of said inlet port;
said outlet pipe being connected to said outlet port and directed horizontally or upwardly from said outlet port;
and
said outlet pipe extending over said evaporator and being connected to said engine.

2. A vehicle air-conditioning system according to claim 1, wherein said inlet pipe is connected to said inlet port and directed horizontally or downwardly from said inlet port, and said inlet pipe extends below said evaporator and is connected to said engine.

3. A vehicle air-conditioning system according to claim 1, wherein said evaporator is substantially standing upright.

4. A vehicle air-conditioning system according to claim 1, wherein said outlet pipe is covered at least partly with an insulation member.

5. A vehicle air-conditioning system according to claim 1, wherein said inlet pipe or said outlet pipe is covered at least partly with a protective cover.

6. A vehicle air-conditioning system according to claim 1, wherein said outlet pipe comprises a bent metal pipe.

7. A vehicle air-conditioning system according to claim 1, wherein said outlet pipe has an uppermost portion, and said engine coolant water is poured through a coolant water inlet disposed at a position higher than said uppermost portion.
